(19) United States
(12) Patent Application Publication
(10) Pub. No.: US 2007/0271957 A1
(43) Pub. Date: Nov. 29, 2007

(54) Process for Producing Glass Strip, Glass Strip and Glass Substrate

(75) Inventors: Toshihiro Nakamura, Tokyo (JP); Tetsuya Kumada, Tokyo (JP); Yasuhiro Naka, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: The Furukawa Electric Co., Ltd., Chiyoda-ku (JP)

(21) Appl. No.: 11/722,964

(22) PCT Filed: Oct. 20, 2005
(86) PCT No.: PCT/JP05/19320

§ 371 Date: Jun. 27, 2007

Related U.S. Application Data
(60) Provisional application No. 60/669,905, filed on Apr. 11, 2005.

(30) Foreign Application Priority Data
Dec. 27, 2004 (JP) 2004-378004

(51) Int. Cl. C03B 23/037; C03B 20/00

(52) U.S. Cl. 65/29.14; 428/220; 65/110

(57) ABSTRACT

A manufacturing method of a glass strip, the method including a heating and drawing process of heating and softening a glass plate preform (1), drawing the glass plate preform to have a desired thickness and forming a glass strip (11), wherein at the heating and drawing process the glass plate preform (1) is drawn so that an internal pressure of a heating furnace (3) is kept positive relative to an atmospheric pressure and so that gas flows introduced to both surfaces of the glass plate preform (1) respectively are equal to each other within the heating furnace (3). It is possible to improve a surface roughness and obtain a desired surface roughness.

### TECHNICAL FIELD

The present invention relates to a manufacturing method of a thin bar-like glass strip by heating and drawing a thick plate-like glass plate preform, a glass strip manufactured by this manufacturing method, and a glass substrate.

### BACKGROUND ART

An improvement in a flatness and an improvement in a surface roughness are most important factors for glass plates used as a substrate of a semiconductor device, a spacer employed in a field effect flat panel display, a magnetic disk substrate, or the like. For a floating method and a molding method currently generally used as a glass plate manufacturing method, by contrast, since a flatness of the manufactured glass plate is low, it is required to grind or polish a surface of the glass plate by a large quantity after manufacturing it to provide a desired flatness. Conventionally, since a surface roughness of even the ground or polished glass plate is still low, the ground or polished glass plate is generally polished again. Since glass plates with higher accuracy are required in the future, it is estimated that the glass plate is polished three times. The conventional method has, therefore, problems in that many steps including grinding and polishing are required, and in that it takes long time and much manufacturing cost to execute all steps.

The conventional method has many steps and is poor in productivity. Considering these problems, there is proposed a method for manufacturing a thin glass plate having a desired thickness by heating and softening a glass plate preform having a predetermined thickness and an improved surface roughness and by drawing the softened glass plate (see, for examples Patent Document 1).

To suppress a waviness of a surface of the thin glass plate obtained by the thin glass plate manufacturing method, there is proposed a method for controlling the surface waviness by disposing an air curtain in a lower portion of a heating furnace that heats the glass plate preform and by cutting off an upcurrent generated within the heating furnace (see, for example, Patent Document 2).

Patent Document 1: Japanese Patent Application Laid-Open No. H11-199255

Patent Document 2 Japanese Patent Application Laid-Open No. H8-183628

### DISCLOSURE OF INVENTION

### Problem to be Solved by the Invention

However, even if the air curtain is disposed in the lower portion of the heating furnace to cut off mixture of the atmosphere from the lower portion thereof as explained in the method disclosed in the Patent Document 2, an unstable convection current of gas is still generated within the heating furnace. Due to this, it is often impossible to suppress the waviness and a bending of the surface of the thin glass plate. In addition, the atmosphere is often mixed into the heating furnace from an upper portion thereof. If the unstable convection current of gas is generated within the heating furnace due to the mixture of the atmosphere from the upper portion of the heating furnace, dust within the atmosphere enters the heating furnace and often adheres to the surface of the obtained thin glass plate.

The glass surface is evaporated while heating the glass plate the evaporated gas is transformed into particles in a low temperature portion within the furnace, and the particles are deposited on the preform that is being drawn or the glass strip after the drawing, thereby causing a surface defect. The evaporated gas corrodes and deteriorates a member within the furnace or reacts with the material within the furnace, thereby generating dust or glass dust. The glass dust is deposited on the preform that is being drawn or the glass strip after the drawing, thereby causing a surface defect.

The present invention has been achieved in view of the conventional problems. It is an object of the present invention to provide a manufacturing method of a glass strip that ensures a high flatness of the glass strip obtained by heating and drawing, ensures a low waviness and a small bending, and reduces adhesion of contaminations to the glass strip after the heating and drawing without increasing cost, a glass strip and a glass substrate.

### Means for Solving Problem

To solve the problems and attain the object, the inventor conducted various experiments. It is discovered that a glass strip having a high flatness can be obtained by drawing a glass plate preform to make gas flows introduced to both surfaces of the glass plate preform equal at a heating and drawing process.

A first glass strip manufacturing method according to the present invention includes a heating and drawing process of heating and softening a glass plate preform within a heating furnace, drawing the glass plate preform to have a desired thickness, and forming a class strip. At the heating and drawing process the glass plate preform is drawn so that an internal pressure of the heating furnace is kept positive relative to an atmospheric pressure and so that gas flows introduced to both surfaces of the glass plate preform, respectively are equal to each other within the heating furnace.

The “both surfaces of the glass plate preform” correspond to two wider surfaces out of vertical and horizontal surfaces of the glass perform plate. The expression “so as to make gas flows introduced . . . equal” means that the glass strip is manufactured so that gas flows are made equal and naturally involves the fact that gas flows eventually differ from each other by various unavoidable external factors.

Furthermore, with a second glass strip manufacturing method according to the present invention, at the heating and drawing process, a gas is introduced to the both surfaces of the glass plate preform independently of each other.

Moreover, with a third glass strip manufacturing method according to the present invention, the gas is preheated before the gas is introduced into the heating furnace.

Furthermore, with a fourth glass strip manufacturing method according to the present invention, a meniscus length while drawing the glass plate preform is 1.5 times or more and ten times or less of a width of the glass plate preform.

Moreover, with a fifth glass strip manufacturing method according to the present invention, at the heating and drawing process, the glass plate preform is heated so that a mean viscosity of the glass plate preform is equal to or higher than 10⁶ poises and so that a lowest viscosity of a meniscus part is equal to or higher than 10^{5.5} poises and equal to or lower than 10^{7.6} poises.

Furthermore, with a sixth glass strip manufacturing method according to the present invention, at the heating and drawing process, the glass strip is manufactured by providing the heating furnace that softens the glass plate preform and an annealing furnace that anneals the glass strip obtained by drawing the glass plate preform and by controlling temperatures of the heating furnace and the annealing furnace independently of each other.

Moreover, with a seventh glass strip manufacturing method according to the present invention, at the heating and drawing process a protection film is formed on a surface of the glass strip before withdrawal.

Furthermore, with an eighth glass strip manufacturing method according to the present invention, at the heating and drawing process, the glass plate preform is drawn so that a drawdown rate is equal to or lower than 20%. The “drawdown rate” means a change of width between before and after the drawing and ((size of width after drawing)/(size of width before drawing)×100).

Moreover, with a ninth glass strip manufacturing method according to the present invention, a cross-sectional aspect ratio of the glass strip is equal to or higher than 10 and equal to or lower than 1000. The “cross-sectional aspect ratio” refers to a ratio of a width and a thickness of a cross section.

Furthermore, with a tenth glass strip manufacturing method according to the present invention, after the heating and drawing process a shape of the glass strip is measured, a difference between a target value of the shape and a measured value is fed back to a drawing mechanism, and a velocity of withdrawing the glass strip is controlled.

Moreover, with an eleventh glass manufacturing method according to the present invention, the measured value is a width of the glass strip.

Furthermore, with a twelfth glass strip manufacturing method according to the present invention, as the glass plate preform, a glass plate consisting of quartz glass is used.

Moreover, with a thirteenth glass strip manufacturing method according to the present invention, as the glass plate preform, a glass plate consisting of multicomponent glass is used.

Furthermore, with a fourteenth glass strip according to the present invention is manufactured by drawing a heated glass plate preform to have a desired thickness. A mean roughness is equal to or smaller than 200 nm and a width is equal to or smaller than 40 mm.

Moreover, with a fifteenth glass strip according to the present invention, a flatness is equal to or lower than 0.5 μm/mm, and a waviness at a wavelength of 1 mm is equal to or smaller than 10 nm. Therefore, lapping step can be simplified and a lapping material having a low polishing rate can be adopted, so that the surface roughness of the glass plate after lapping can be improved.

The “flatness” refers to a difference between a maximum point and a minimum point in a vertical direction at two arbitrary points on a substrate surface away from each other by 1 mm when a strip is cut out as a substrate having a necessary area and then the entire substrate is put on a horizontal plane. The “waviness at a wavelength of 1 mm” refers to a waviness measured by a measurement device: ZYGO NEW VIEW200 (ZYGO Corporation), and refers to a mean roughness of regions at all wavelengths equal to or larger than 50 micrometers within a measurement surface range of (0.85 mm)×(0.64 mm). The “mean roughness” refers to a roughness measured based on JIS-B0601-2001 and particularly to an arithmetic mean height Ra.

Furthermore, with a sixteenth glass strip according to the present invention, a flatness is equal to or lower than 0.25 μm/mm, a waviness at a wavelength of 1 mm is equal to or smaller than 10 nm, and the mean roughness is equal to or smaller than 100 nm. Thus, it is possible to dispense with the lapping step depending on purpose.

Moreover, with a seventeenth glass strip according to the present invention, a flatness is equal to or lower than 0.15 μm/mm, a waviness at a wavelength of 1 mm is equal to or smaller than 0.5 nanometer, and the mean roughness is equal to or smaller than 2 nm. Thus, it is possible to dispense with the lapping step and the primary polishing step depending on purpose.

Furthermore, with an eighteenth glass strip according to the present invention, a flatness is equal to or lower than 0.05 μm/mm a waviness at a wavelength of 1 mm is equal to or smaller than 0.2 nanometer, and the mean roughness is equal to or smaller than 0.5 nanometer. Thus, it is possible to execute only the final polishing step.

Moreover, with a nineteenth glass strip according to the present invention, a material for the glass strip is quartz glass.

Furthermore, with a twentieth glass strip according to the present invention, a material for the glass strip is multicomponent glass.

Moreover, a twenty first glass substrate according to the present invention is manufactured by drawing a heated glass plate preform to have a desired thickness. A mean roughness is equal to or smaller than 200 am and a width is equal to or smaller than 40 mm.

### BRIEF DESCRIPTION OF DRAWINGS

FIG. 1 is a schematic view of a peaked shape forming step in a manufacturing method of a glass strip according to the present invention.

FIG. 2 is a schematic view of a support rod connected with a proximal end of a glass plate preform.

FIG. 3 is a perspective view of a hot drawer, depicting a heating and drawing process in a glass strip manufacturing method according to a first embodiment of the present invention.

FIG. 4 is a schematic view of a method for introducing gas into a heating furnace conducted in the glass strip manufacturing method according to the invention.

FIG. 5 is a graph of a drawdown rate during drawing.

FIG. 6 is a graph of a change rate of a cross-sectional aspect ratio according to a viscosity of the glass plate preform.

### EXPLANATIONS OF LETTERS OR NUMERALS

1 Glass plate preform
2 Heater
3 Support rod
10 Heating furnace
11 Glass strip
15 Heater

### BEST MODE(S) FOR CARRYING OUT THE INVENTION

Exemplary embodiments of a manufacturing method of a glass Strip according to the present invention are explained in detail below with reference to the accompanying drawings. The present invention is not limited by the embodiments

### First Embodiment

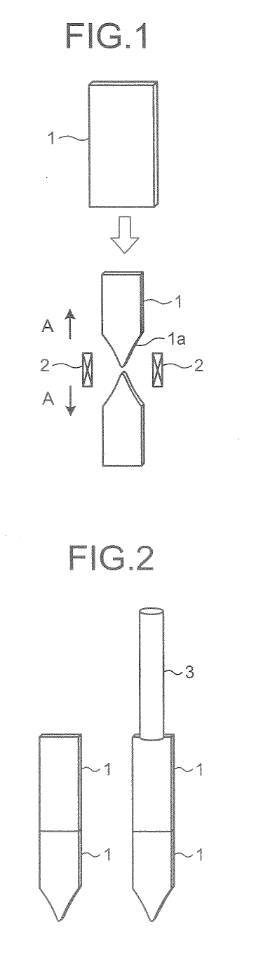

FIG. 1 is a schematic view of a peaked shape forming step in a manufacturing method of a glass strip according to the present invention. According to the first embodiments a long plane glass plate preform 1 is used as a preform. A material for the glass plate preform 1 is quartz glass. To make the glass plate preform 1 have a surface state in which a thickness is constant and a flatness falls within a predetermined range (0.1 mm/100 mm to 0.01 mm/100 mm), the glass plate preform 1 is ground from both surfaces thereof. Thereafter, the glass plate preform 1 is subjected to flame polishing or mechanical polishing until it becomes substantially transparent. To prevent cracking, corners of the glass plate preform 1 are chamfered to 0.5 mm radius or more A glass plate preform having a length of about 1 meter, a width of 350.5 mm, a thickness of 10.8 mm, and a surface roughness Ra of 0.05 micrometer is used. A cross-sectional aspect ratio of the glass plate preform 1 is 32.45. At this step, a tip end of the glass plate preform 1 is made peaked to form a pyramid portion on the tip end to facilitate a first drawing operation at a next heating and drawing process. In this embodiment, the pyramid portion is formed by fusing the glass plate preform 1 by a heater 2. However, the formation method is not limited thereto.

At this step, a longitudinal intermediate portion 1a of the glass plate preform 1 is preheated by the heater 2 and longitudinal both ends of the glass plate preform 1 are pulled in A directions, respectively. Thus, the intermediate portion 1a is fused the tip end of the glass plate preform 1 is made substantially triangular, and the pyramid portion is formed on an apex of the triangle. This enables smooth operation of initially drawing the glass plate preform at the next heating and drawing process.

FIG. 2 is a schema view of a support rod 3 connected with a proximal end of the glass plate preform 1. After tip ends and rear ends of several glass plate preforms 1 are coupled with one another to provide a predetermined lengths the support rod 3 is connected with the proximal end of a rear glass plate preform 1. This facilitates inputting the glass plate preform 1 into a hot drawer, and the glass plate preform 1 can be used up to its proximal end without wasting any part of it.

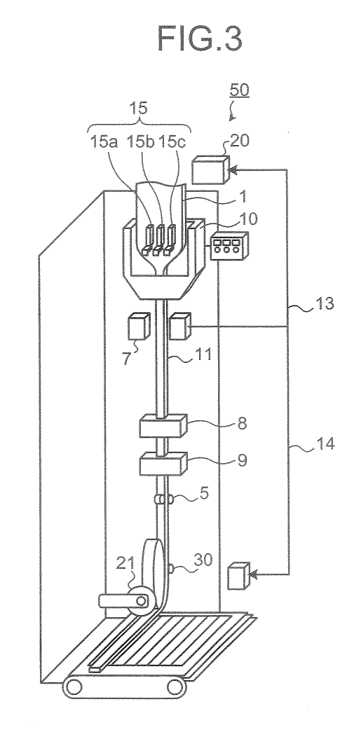

FIG. 3 is a perspective view of the hot drawer, depicting the heating and drawing process in the glass strip manufacturing method according to the first embodiment. In this embodiment, a heating step of heating the glass plate preform and a drawing process of drawing the heated and softened glass plate preform into a desired thickness are simultaneously executed. A hot drawer 50 includes a heating furnace 10, which is an electric resistance furnace that heats the glass plate preform 1, a preform feed mechanism 20 that feeds the glass plate preform 1 into the heating furnace 10, and a withdrawal mechanism 30 that withdraws the glass plate preform 1 from the heating furnace 10. A heater 15 serving as a heating unit that heats the glass plate preform 1 is disposed in the heating furnace 10.

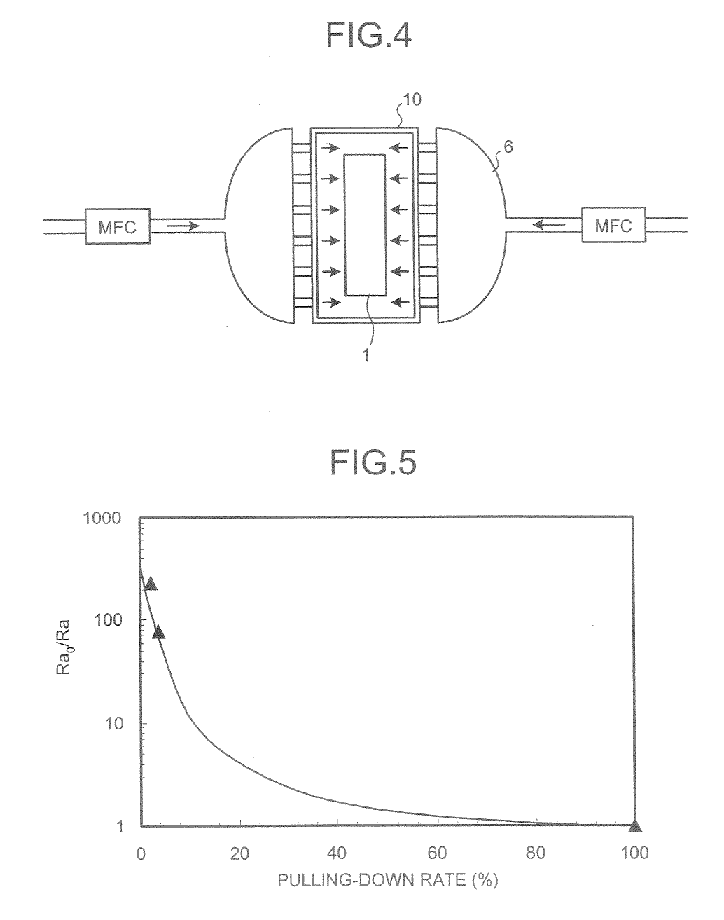

A gas flange 6 is provided in an upper portion of the heating furnace 10 to introduce gas to the both surfaces of the glass plate preform 1 independently of each other, to keep an internal pressure of the heating furnace 10 positive relative to an atmospheric pressure, and to make gas flows introduced to the both surfaces of the glass plate preform 1 equal. FIG. 4 is a cross-sectional top view of the heating furnace 10, as an example of a method for introducing the gas into the heating furnace. As shown in FIG. 4 the gas is introduced to the both surfaces of the glass plate preform 1 and flow rates of the gas introduced to the both surfaces thereof are controlled by mass flow controllers (MFCs), respectively. A gas Inlet is preferably divided into a plurality of inlets on one surface, whereby a uniform temperature distribution in a width direction of the glass plate preform 1 can be obtained. Two or more gas inlets are preferably provided in a drawing direction. With this arrangement, it is possible to ensure preventing mixture of the atmosphere into the heating furnace.

By using such a method, descending gas flows are created within the heating furnace to prevent generation of an unstable convection current of gas. By thus forcibly creating the gas flows within the furnace, stable flows can be realized in a longitudinal direction and heat conduction between the gas and the glass plate preform or the glass strip after drawing is stabilized. Therefore, the flatness of the surface of the glass strip can be improved. Since solidified portions of a meniscus are made equal between both surfaces of the glass strip, the bending of the glass strip can be suppressed. Besides, by keeping the internal pressure of the heating furnace 10 positive relative to the atmospheric pressure, mixture of dust into the heating furnace 10 can be prevented.

Alternatively, ascending gas flows can be created within the heating furnace.

N₂, Ar, He, or a mixture thereof is used as the gas introduced into the heating furnace. If a multicomponent glass is used for the glass plate preform, the atmosphere can be used as the gas introduced into the heating furnace, in which case, the clean air with a lower water content is preferably used. It is also preferable to preheat the gas introduced into the heat in furnace to about 400° C. to 1200° C. A preheating temperature is appropriately adjusted according to the material for the glass plate preform. It is efficient if a heat generated by the heating furnace or an annealing furnace is used as the preheat since it is unnecessary to separately provide a gas preheating heater.

In this embodiment, the glass plate preform consisting of the quartz glass is used. The preform feed mechanism 20 moves the glass plate preform 1 at a velocity of about 4 mm/min. The heating furnace 10 heats the glass plate preform 1 at a temperature of about 1850° C. At this moment, the glass plate preform 1 has a viscosity of 10⁶ poises. Therefore, the glass plate preform 1 is softened. The withdrawal mechanism 30 withdraws a softened glass plate preform 1 at a velocity of about 5 m/min. At this moment, a meniscus length is 550 mm. The “meniscus length” means herein a distance from a part having the same preform width as an original preform width to a part having a width equal to that of a glass strip to be formed. The length of the meniscus thus formed is controlled to be equal to or greater than 1.5 times and equal to or less than ten times as large as a width of the preform by a structure of the heater within the furnace. The meniscus length can be increased by setting a temperature distribution of the heating furnace in a withdrawal direction as a broad and increasing a heat zone. Preheating the gas introduced into the furnace also contributes to increasing the meniscus length.

As shown in FIG. 3 an annealing furnace that anneals the glass strip may be provided between the heating furnace 10 and an outside diameter meter 7. The annealing furnace is preferably set to be able to anneal the glass strip in a temperature range from half to two-thirds of a glass material softening temperature. If the glass plate preform consists of the quartz glass, a temperature of the annealing furnace is preferably about 800° C. By providing the annealing furnace, strains of the glass strip are released and a glass strip having fewer surface defects can be obtained.

A protection-film coating device 8 is disposed under the outside diameter meter. It is preferable that the protection-film coating device 8 forms a protection film consisting of resin, amorphous carbon, or a self-lubricating material on a surface of a glass strip 11 before the glass strip 11 contacts with a guide roll 5. A thickness of the coating is preferably 0.1 to 10 micrometers, with which it is possible to reduce damages on the surface of the glass strip 11 and to prevent adhesion of contaminations to the surface of the glass strip 11. The glass strip 11 having the protection film formed on the surface is high in strength, so that the glass strip 11 can be wound around a bobbin or the like without cutting the glass strip 11 by a cutter depending on a width or a thickness thereof.

A tension meter 9 is disposed under the protection-film coating device 8. The tension meter 9 measures a tension for withdrawing the glass strip 11. By controlling the temperature of the heating furnace so that the tension measured by the tension meter is constant, a shape of the glass strip obtained by the drawing can be stabilized. If the measured tension is high, the temperature of the heating furnace is raised. If the measured tension is low, the temperature is reduced.

As a result, the glass plate preform 1 is drawn to the class strip 11 having a width of 20.58 mm and a thickness of 0.601 mm Namely, the glass strip having a cross-sectional aspect ratio of 34.24 is formed. In this embodiment, with a view of improving the flatness of the glass strip 11 thus formed, reducing the surface waviness and the bending of the glass strip, and reducing adhesion of contaminations to the glass strip after heating and drawing, the drawing is performed so as to keep the internal pressure of the heating furnace positive relative to the atmospheric pressure and to make the gas flows introduced to the both surfaces of the glass plate preform equal in the heating furnace. The glass strip 11 obtained in this embodiment has a waviness of 2 nm and a flatness of 0.2 μm/mm. An adhesion rate of the contaminations adhering to the surface is 0.01 piece/m. The contaminations are measured by an optical microscope or an electron microscope and the waviness is measured by an AFM (atomic force microscope), a laser microscope, or a stylus roughness meter.

At this time, a drawdown rate is about 6% and a mean surface roughness (Ra) is 4 nm. FIG. 5 is a graph for explaining a drawdown rate during the drawing. In FIG. 5 a horizontal axis indicates the drawdown rate and a vertical axis indicates the surface roughness. Ra indicates an arithmetic mean height defined in JIS B0601-2001 and is used to represent the surface roughness. Herein, a roughness change is expressed by Ra₀/Ra, which indicates how Ra is changed from Ra (Ra₀) before the drawing when the glass plate preform is drawn at a predetermined drawdown rate. It is discovered that by drawing the glass plate preform so that the drawdown rate is equal to or lower than 20%, the surface roughness can be improved as compared with the glass plate preform 1 before the drawing. It is also discovered that a desired surface roughness can be obtained.

The glass a plate preform 1 consisting of the quartz glass is drawn at the same drawdown rate as that according to the first embodiment with only the temperature changed. If a temperature of the heater that heats the glass plate preform 1 is set to 1790° C., an absolute value of a change rate of the cross-sectional aspect ratio is 6.3% and a surface roughness Ra is 8 nm. At this moment, the viscosity of the glass plate preform 1 is about 10⁷ poises. “The change of the cross-sectional aspect ratio is equal to or smaller than 7%” means that the absolute value of the change rate of the cross-sectional aspect ratio ((1-(cross-sectional aspect ratio before drawing)/(cross-sectional aspect ratio after drawing)) is equal to or smaller than 7%. If the temperature of the heating furnace is set to 1980° C., then the viscosity of the glass plate preform 1 is about 10⁵ poises, the absolute value of the change rate of the cross-sectional aspect ratio is 49.6%, and the surface roughness Ra is 1.7 nm. After thus repeating various experiments, the inventor has discovered that a glass strip having a high flatness can be obtained by heating and drawing the glass plate preform so that the cross-sectional aspect ratio of the glass plate preform before heating and drawing is equal to that of the glass strip after heating and drawing.

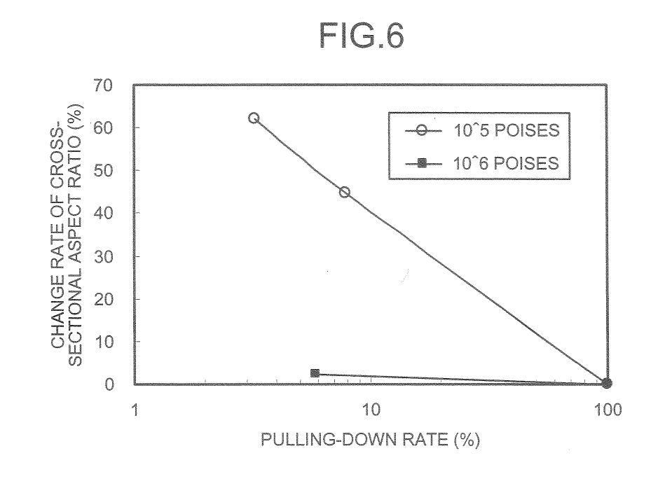

FIG. 6 is a graph of the drawdown rate and the change rate of the cross-sectional aspect ratio when the viscosity of the glass plate preform 1 is changed. In FIG. 6, a horizontal axis indicates the drawdown rate and a vertical axis indicates the change rate of the cross-sectional aspect ratio. As shown in FIG. 5, in drawing the glass plate preform 1 at a temperature at which the viscosity of the glass plate preform 1 is 10⁵ poise, if the drawdown rate is reduced, the change rate of the cross-sectional aspect ratio increased. In drawing the glass plate preform 1 at a temperature at which the viscosity of the glass plate preform 1 is 10⁶ poises, even if the drawdown rate is reduced, the change rate of the cross-sectional aspect ratio can be kept low. To heat and draw the glass plate preform 1 without changing the cross-sectional aspect ratio, therefore, the viscosity of the glass plate preform 1 is preferably set to be equal to or higher than 10⁶ poises. If a lowest viscosity of the meniscus part is set to be equal to or higher than 1 poises and equal to or lower than 10^{7.6} poises the change rate of the cross-sectional aspect ratio can be further reduced.

After the flatness and the surface roughness of the glass plate preform 1 before the drawing are increased to 0.5 or −0.5 micrometer and 0.01 micrometer, respectively, the glass plate preform 1 is drawn under conditions that the change rate of the cross-sectional aspect ratio is equal to or lower than 7% and that the drawdown rate is equal to or lower than 20% Thus, the glass strip 11 having a flatness of 0.05 μm/mm and a surface roughness of 0.5 nanometer can be obtained. The flatness and the surface roughness of the obtained glass strip 11 can be arbitrarily changed by changing those of the glass plate preform 1 before the drawing, respectively.

The guide roll 5 for preventing twisting of the glass strip 11 is provided on a withdrawal side of the heating furnace 10. The measuring device 7 is provided between the heating furnace 10 and the guide roll 5. The measuring device 7 measures the shape of the glass strip 11. However, since it is not easy to continuously and accurately measure the thickness of the glass strip 11 reduced to about 0.5 mm, the measuring device is used to measure the width of the glass strip 11. The measuring device is preferably disposed right under the drawers, in which case, a solidifying point of the meniscus is located within the furnace.

A measured value obtained by the measuring device 7 is fed back to the preform feed mechanism 20 via a feedback route 13. The preform feed mechanism 20 controls a preform feed velocity based on this feedback value. The measured value obtained by the measuring device 7 is also fed back to the withdrawal mechanism 30 via a feedback route 14. The withdrawal mechanism 30 controls a withdrawal velocity based on the feedback value. In this embodiment, velocity is controlled while a withdrawal velocity control is assumed as a main control and a preform feed velocity control is assumed a sub control so as to stabilize the shape of the glass strip 11 after the drawing. A withdrawal velocity control cycle is 0.1 to 2 seconds whereas a preform feed velocity control cycle is set 10 to 100 times as long as the withdrawal velocity control cycle, thereby eliminating control system Interference.

A heating operation (heating and drawing process) executed within the heating furnace 10 is explained. At the heating and drawing process, the glass plate preform 1 is heated so that the mean viscosity of the glass plate preform 1 is equal to or higher than 10⁶ poises. If the glass plate preform 1 having a rectangular cross section is used, a non-flat temperature distribution tends to occur to the preform because of the difference in heat conduction between the width direction and the thickness direction. Due to this the glass plate preform 1 is heated while a temperature distribution in a space formed by the heater is made non-uniform in the width direction. Specifically the temperature distribution is controlled to be non-uniform by, for examples three heaters 15a, 15b, and 15c arranged in a direction perpendicular to a direction to a forward direction of the glass plate preform and controllable independently of one another.

A groove is cut out in a surface of the glass strip 11 thus formed by a cutter 21 provided downstream of the withdrawal mechanism 30, and the resultant glass strip 11 is bent and cut by a capstan (not shown) to have a uniform length of about 1 meter.

Alternatively, a unit that forcibly cools the glass strip 11, such as an air blower may be provided downstream of the heating furnace 10 whereby the surface of the glass strip 11 is quickly cooled so as to increase a hardness of the surface of the glass strip 11 which is not completely solidified and to prevent the surface of the glass strip 11 from being damaged by the guide roll 5 or the like.

In this embodiment, the glass plate preform 1 consisting of the quartz glass is used. Alternatively, the glass plate preform 1 consisting of a material that contains multicomponent glass such as alumina containing borate-containing, or soda lime-containing multicomponent glass as well as alkali metal and metal, and a material having a lower softening temperature than that of the quartz glass may be used. The multicomponent glass is normally lower in softening temperature than the quartz glass and can be machined by a relatively simple heating device. For example, the borate-containing glass can be machined at about 1260° C. if such a multicomponent glass is used, machining temperature is adjusted to an optimum temperature for the material. Specifically, a machining temperature at which the mean viscosity of the glass plate preform is equal to or higher than 10⁶ poises and at which the lowest viscosity of the meniscus part is equal to or higher than 10^{5.5} poises and equal to or lower than 10^{7.6} poises may be selected. The quartz glass having the higher softening temperature, by contrast, needs to be heated to high temperature and installation load is high. However, with the quartz glass, the glass strip having a sufficient strength to be used can be obtained without a later reinforcing step.

### Second Embodiment

According to a second embodiment, at a heating and drawing process, nitrogen gas is introduced into the heating furnace 10 and surfaces of the glass strip 11 are doped with nitrogen to improve rigidity of the surfaces thereof. In addition, right after the heating and drawing process the glass strip 11 is caused to pass through an ammonium gas atmosphere and the surfaces of the glass strip 11 are doped with nitrogen to improve the rigidity of the surfaces thereof. Similarly to the first embodiment, gas is introduced to the both surfaces of the glass plate preform 1 independently of each other, the internal pressure of the heating furnace 10 is kept positive relative to the atmospheric pressure, and the gas flows introduced to the both surfaces of the glass plate preform 1 are made equal to each other.

By thus improving the rigidity of the surface of the glass strip 11, it is possible to prevent the surface of the glass strip 11 from being damaged by the guide roll 5 or the like. Preferably, a protection film consisting of resin, amorphous carbon, or a self-lubricating material is formed on the surface of the glass strip 11.

In this embodiment, the surfaces of the glass strip 11 are reinforced by doping the surfaces thereof with nitrogen. Alternatively, after the surfaces of the glass strip 11 are doped with nitrogen right after heating and drawing, the protection film consisting of resin, amorphous carbon or the self-lubricating material may be formed on the glass strip 11 to prevent the surfaces of the glass strip 11 from being damaged.

A magnetic disk substrate is formed out of the glass strip obtained according to the first embodiment.

The obtained glass strip is first cut off into a desired shape. A density degenerated layers on which a compressive stress acts, is formed within a substrate glass near a cut surface chemically (by an etching with a low concentration hydrofluoric acid aqueous solution), mechanically (by polishing, lapping or the like), by coating the cut surfaces with an inorganic matter such as quartz or titanium oxide, or by a femtosecond laser. Thereafter the protection film is peeled off so as not to damage the glass strip by a wet process using a solvent or an ultrasonic wave or by a dry process using O₂ plasma.

The substrate surface is polished using a colloidal silica slurry, thereby polishing one surface by 0.2 micrometer. It is thus possible to eliminate a distorted layer on the surface and also simultaneously eliminate contaminations and scratches on the surface. It takes about 10 minutes to perform this polishing.

According to the present invention, a ground amount by polishing can be reduced.

### FIRST EXAMPLE

A glass plate preform having a width of 100 mm and a thickness of 2 mm is used. A surface roughness Ra of the glass plate preform is 73 nm. The glass plate preform is drawn by a drawing furnace by the manufacturing method according to the present invention. As a result, a glass plate having a width of 22.3 firm and a thickness of 45 mm is obtained. A drawdown rate is 20%. Finally, a glass strip having a flatness of 1 μm/mm, a waviness of 9 nm, and a roughness Ra of 10 nm is manufactured.

### SECOND EXAMPLE

A glass plate preform of the same size as that of the glass plate preform in the first example is used. Helium gas is introduced by 10 l/min into the drawing furnace and the glass plate preform is heated at the same temperature as that in the first example. As a result of drawing the glass plate preform by the drawing furnace, a glass strip having a flatness of 0.1 m/mm, a waviness of 2 nm, and a roughness Ra of 30 nm is manufactured.

Due to the action of the helium gas having excellent heat conductivity, the glass is evenly heated to simultaneously improve the flatness and the waviness. However, since the heat conduction of the helium gas reduces a surface temperature of the glass and increases a viscosity of the glass, the roughness is deteriorated.

### THIRD EXAMPLE

If the glass plate preform put into the drawing furnace, the glass strip at a position of the outside diameter meter shown in FIG. 3, and the glass strip at a position of the withdrawal mechanism 30 shown in FIG. 3 are located relative to one another so that respective axial centerlines thereof are not aligned linearly, the glass plate is gradually drawn obliquely. The manufactured glass strip is, therefore, warped.

This warping quantitatively expresses a synonym for, for example, the flatness. In this example, the flatness is 10 μm/mm or more.

### FOURTH EXAMPLE

If a distance between a withdrawal tip end of the preform and an inlet of a withdrawal machine is about 3 meters, a withdrawal machine alignment is adjusted so that a deviation from a line that connects the withdrawal tip end and the inlet to the axial centerline of the glass plate preform is within 0.1 mm at the position of the withdrawal machine. By doing so, the manufactured glass strip is not warped.

### FIFTH EXAMPLE

The glass plate preform is pre-finished to have a width of 100 mm, a thickness of 2 mm, and a surface roughness Ra of 4 nm. As a result of drawing the glass plate preform by the drawing furnace, a glass plate having a width of 22.3 mm and a thickness of 0.45 mm is obtained. The drawdown rate is 20%. Finally, a glass strip having a flatness of 1 μm/m, a waviness of 2 nm, and a roughness Ra of 0.6 nanometer is manufactured.

The roughness of the finished glass strip is improved as compared with the first example. This is due to reduction of the roughness of the glass plate preform. Using the colloidal silica slurry, the substrate surface is polished for about 10 minutes. As a result, although the roughness Ra is improved to 0.3 nanometer, the waviness is hardly reduced.

### SIXTH EXAMPLE

The glass plate preform is pre-finished to have a width of 100 mm, a thickness of 2 mm and a surface roughness Ra of 4 nm. The glass plate preform is input into the drawing furnace into which helium gas is introduced by 10 l/min, heated at the same temperature as that in the fifth example, and drawn. As a result, a glass plate having a width of 22.3 mm and a thickness of 0.45 mm is obtained. The drawdown rate 20%. Finally a glass strip having a flatness of 1 μm/mm a waviness of 0.45 nanometer, and a roughness 1a of 2 nm is manufactured.

The roughness of the finished glass strip is improved as compared with the first example. Using the colloidal silica slurry, the substrate surface is polished for about 10 minutes. As a result, the roughness Ra is improved to 0.3 nanometer and the waviness is reduced to 0.15 nanometer.

The fifth example is compared with the sixth example. In a polishing process, it is more difficult to eliminate the waviness at a wavelength of 1 mm than to eliminate roughness. To manufacture the glass substrate according to the present invention as the magnetic disk substrate, it is effective to make the waviness smaller as the glass strip having a waviness of 0.5 nanometer or less and a roughness of 2 nm or less. As a method therefor, the heat conduction of the gas introduced into the drawing furnace and the temperature of the furnace are adjusted thereby controlling the relationship between the waviness of the finished glass plate and the roughness thereof.

As explained above, the glass strip manufactured by the glass strip manufacturing method according to the present invention can be applied to various products or which the flatness and the surface property of the glass strip are made use of. For example, the glass strip is suitable as a material for a spacer or a substrate of a semiconductor element or a field effect flat panel display.

1. A manufacturing method of a glass strip, the method comprising a heating and drawing process of heating and softening a glass plate preform within a heating furnace, drawing the glass plate preform to have a desired thickness, and forming a glass strip, wherein
at the heating and drawing process, the glass plate preform is drawn so that an internal pressure of the heating furnace is kept positive relative to an atmospheric pressure and so that gas flows introduced to both surfaces of the glass plate preform, respectively are equal to each other within the heating furnace.

2. The glass strip manufacturing method according to claim 1, wherein at the heating and drawing process, a gas is introduced to the both surfaces of the glass plate preform independently of each other.

3. The glass strip manufacturing method according to claim 1, wherein the gas is preheated before the gas is introduced into the heating furnace.

4. The glass strip manufacturing method according to claim 1, wherein a meniscus length while drawing the glass plate preform is 1.5 times or more and ten times or less of a width of the glass plate preform.

5. The glass strip manufacturing method according to claim 1, wherein at the heating and drawing process the glass plate preform is heated so that a mean viscosity of the glass plate preform is equal to or higher than 10⁶ poises and so that a lowest viscosity of a meniscus part is equal to or higher than 10^{5.5} poises and equal to or lower than 10^{7.6} poises.

6. The glass strip manufacturing method according to claim 1, wherein at the heating and drawing process, the glass strip is manufactured by providing the heating furnace that softens the glass plate preform and an annealing furnace that anneals the glass strip obtained by drawing the glass plate preform and by controlling temperatures of the heating furnace and the annealing furnace independently of each other.

7. The glass strip manufacturing method according to claim 1, wherein at the heating and drawing process, a protection film is formed on a surface of the glass strip before withdrawal.

8. The glass strip manufacturing method according to claim 1, wherein at the heating and drawing process, the glass plate preform is drawn so that a drawdown rate is equal to or lower than 20%.

9. The glass strip manufacturing method according to claim 1, wherein a cross-sectional aspect ratio of the glass strip is equal to or higher than 10 and equal to or lower than 1000.

10. The glass strip manufacturing method according to claim 1, wherein after the heating and drawing process, a shape of the glass strip is measured a difference between a target value of the shape and a measured value is fed back to a drawing mechanism, and a velocity of withdrawing the glass strip is controlled.

11. The glass strip manufacturing method according to claim 10, wherein the measured value is a width of the glass strip.

12. The glass strip manufacturing method according to claim 1, wherein as the glass plate preform, a glass plate consisting of quartz glass is used.

13. The glass strip manufacturing method according to claim 1, wherein as the glass plate preform, a glass plate consisting of multicomponent glass is used.

14. A glass strip manufactured by drawing a heated glass plate preform to have a desired thickness, wherein
a mean roughness is equal to or smaller than 200 nm and a width is equal to or smaller than 40 mm.

15. The glass strip according to claim 14, wherein a flatness is equal to or lower than 0.5 μm/mm and a waviness at a wavelength of 1 mm is equal to or smaller than 10 nm.

16. The glass strip according to claim 14, wherein a flatness is equal to or lower than 0.25 μm/mm a waviness at a wavelength of 1 mm is equal to or smaller than 10 nm, and the mean roughness is equal to or smaller than 100 nm.

17. The glass strip according to claim 14, wherein a flatness is equal to or lower than 0.15 μm/mm a waviness at a wavelength of 1 mm is equal to or smaller than 0.5 nanometer, and the mean roughness is equal to or smaller than 2 nm.

18. The glass strip according to claim 14, wherein a flatness is equal to or lower than 0.05 μm/mm, a waviness at a wavelength of 1 mm is equal to or smaller than 0.2 nanometer, and the mean roughness is equal to or smaller than 0.5 nanometer.

19. The glass strip according to claim 14, wherein a material for the glass strip is quartz glass.

20. The glass strip according to claim 14, wherein a material for the glass strip is multicomponent glass.

21. A glass substrate manufactured by drawing a heated glass plate preform to have a desired thickness, wherein
a mean roughness is equal to or smaller than 200 nm and a width is equal to or smaller than 40 mm.
